(19) United States
(12) Patent Application Publication
(10) Pub. No.: US 2006/0010050 A1
(43) Pub. Date: Jan. 12, 2006

(54) Income tax preparation kiosk

(76) Inventor: Fredrick Earl Dowdell, Birmingham, AL (US)

Correspondence Address: Fredrick Earl Dowdell, 345 23rd St. S.W., Birmingham, AL, 35211-3012, US

(21) Appl. No.: 10/710,251

(22) Filed: Jun. 29, 2004

(51) Int. Cl. G06F 17/60

(52) U.S. Cl. 705/31

(57) ABSTRACT

The Income Tax Preparation Kiosk will allow for a more intimate setting with clients of heavier workloads for any income tax preparer/accountant. Much of the RAL clients' income tax preparation is automated and depends on the efficiency of the preparer. This kiosk will minimize the time spent on returns that are due 100% and more earned income credit. This will provide more quality time for the more involved client. Leaving the more simple, income tax preparation, tasks to the kiosk will allow for less waiting and more precise preparation of more involved clients. Reducing the number of audits and easing the pinch on taxpayers.

An automated kiosk linked to the central databases of Dumas & Associates, Incorporated who will then access IRS and various software databases so customers can input criteria requested by the linked database from Dumas & Associates, Incorporated.

Customers will be able to pay at the kiosk with cash, credit or debit cards. The kiosk will provide the customer with their copies of an IRS forms for the year they are filing, and they will be able to go to any kiosk linked to the data base the next day and receive a check from the kiosk or an explanation as to why their check is not available.

1. The kiosk that receives and scans data to be processed by the data base/individuals receiving the data input at kiosk or some other remote location. Said kiosk will produce a copy of documents pertaining to the tax year requested by the customer. Said kiosk will produce all documentation relative to the customer receiving an income tax refund check and audit information:

2. The kiosk of claim 1 will consist of a monitor standing erect or flat depending on space allocation specs.

3. The kiosk of claim 1 will consist of a keyboard in a protective plastic covering lying 4½ ft. above the base of the kiosk in an 180 degree angle of the base of said kiosk for external exposure and use.

4. The kiosk of claim 1 will consist of a scanner laying parallel to the base of the kiosk 3 ft. above the base of said kiosk for external exposure and use.

5. The kiosk of claim 1 will consist of a digital signature pad with wand integrated with the scanner of claim 4.

6. The kiosk of claim 1 will have debit/credit card magnetic swipe mechanisms attached 4¼ ft. from the base of said kiosk.

7. The kiosk of claim 1 will have an output slot for forms and other documentation 3½ ft. from the base of the said kiosk.

8. The kiosk of claim 1 will have an output slot for checks 2¾ ft. above the base of said kiosk.

9. The kiosk of claim 1 will have an input slot for cash bills and change 2¾ ft. above the base of said kiosk connected to an interior cash money repository.

10. The kiosk of claim 1 will have a cash money repository box 2¾ ft. above the base in the interior of said kiosk.

11. Said kiosk will be have an external covering of fiberglass, plastic, metal, wood/other durable material. Said kiosk will have this covering its full length and width which also will be used for storage inside said kiosk. The height and width of said kiosk will depend on space allocation specs.

12. A method for inputting W2's, scanning social security cards, drivers licenses/any other pertinent information for receiving income tax refund checks.

13. An automated method for payment of services.

14. An automated method of calculating income taxes.

15. An automated method of issuing income tax refund checks.

16. The method according to claims 12-15 whereby refund anticipation loans and bonus as well as direct deposits of income tax refund recipients will be able to have automated access in inputting, calculating and receiving income tax data and income tax refund checks.
